(19) United States
(12) Patent Application Publication
(10) Pub. No.: US 2025/0228411 A1
(43) Pub. Date: Jul. 17, 2025

(54) Universal Sink Grate

(71) Applicant: Danco, Inc., Irving, TX (US)

(72) Inventors: Robert Jones, JR., Rockwall, TX (US); Les Underwood, Haslet, TX (US)

(21) Appl. No.: 19/009,636

(22) Filed: Jan. 3, 2025

Related U.S. Application Data
(60) Provisional application No. 63/621,866, filed on Jan. 17, 2024.

(51) Int. Cl. A47J 47/20

(52) U.S. Cl. CPC A47J 47/20

(57) ABSTRACT

A universal sink grate system comprising a primary grate and either an adjustable grate extension and/or removable drain guard. The primary grate may comprise a grid of support members to prevent kitchenware from passing through while allowing liquid and smaller debris to pass. An inner rail defines a grate aperture that may be off-center relative to the primary grate. One or more grate extensions may be selectively positioned to extend a length and/or width of the grid to substantially cover a bottom surface of sinks of different sizes. A drain guard may be aligned and selectively positioned with the grate aperture to selectively obstruct a portion and leave another portion unobstructed. The system may be configured to place the unobstructed portion of the grate aperture in alignment with a sink drain to allow access to the sink drain in various sinks with different drain positions.

### CROSS-REFERENCE TO RELATED APPLICATION

This application claims the benefit of U.S. Provisional Application Ser. No. 63/621,866 filed on Jan. 17, 2024.

### TECHNICAL FIELD

This disclosure relates generally to mechanical devices that protect the bottom surfaces of sinks, including coatings on such surfaces, and that allow selectively positional access to a drain in a sink.

### BACKGROUND

Sinks are often used for cleaning used kitchenware and eating utensils, typically by soaking, scrubbing, and rinsing. Sinks may be used in home kitchens, recreational vehicles, outdoor patios, bathrooms, laboratories, and restaurants, for example. Sinks may come in different shapes and sizes and are readily familiar to one of ordinary skill. Generally, residential household kitchen sinks have similar width (front to back) dimensions as they are configured to fit on or within a base cabinet, which is typically 24 inches from front to back. However, the length (from side to side) of residential household kitchen sinks can vary.

Sinks typically have drain holes through which liquids and debris may be washed out for easy disposal. Rubber stoppers may be used to plug drain holes to allow the sink to hold liquid. The drain hole of a sink may not necessarily be located in the geometric center of its bottom surface, however. The drain hole may be located in a rear center, rear corner, or side center, for example.

Sinks are often made of metal, such as stainless steel, sheet, copper, or cast iron, that has been formed into shapes having smooth walls and bottoms. Sinks may also be made of metal that have been coated with a ceramic or enamel layer, to provide a porcelain finish, for example. Sinks may also be formed of stone or composite materials. Sinks may also have finish coatings to provide a particular coloration to the sink, such as black or a gold tone.

Unfortunately, a bottom surface of a sink, and particularly finish coating layers thereon, are susceptible to damage during usage, such as scratches or cracking caused by abrasions and impacts from pots or utensils or other implements. Therefore, a need exists for a sink grate system that can protect the bottom surfaces of sinks from damage, that can provide protection while not interfering with access to a drain, and that allows for size adjustability and use with sinks having different drain locations.

### BRIEF SUMMARY

In one preferred embodiment, a sink grate system comprises a primary grate and a single grate extension that is selectively extendable in a lateral or longitudinal direction from the primary grate, wherein overall physical dimensions of the sink grate system are adjustable based on a degree of lateral or longitudinal extension of the single grate extension. In another preferred embodiment, a sink grate system comprises multiple grate extensions that are selectively extendable in a lateral and/or longitudinal direction from the primary grate, wherein overall physical dimensions of the sink grate system are adjustable based on a degree of lateral and/or longitudinal extension of one or more of the multiple grate extensions. In still another preferred embodiment, a sink grate system comprises a primary grate, at least one grate extension configured to extend laterally from the primary grate, and at least one grate extension configured to extend longitudinally from the primary grate. In still another preferred embodiment, a sink grate system comprises a primary grate, a first grate extension configured to extend laterally from the primary grate, a second grate extension configured to extend longitudinally from the primary grate, and a third grate extension configured to extend either longitudinally from the first grate extension or laterally from the second grate extension.

In one embodiment, a primary grate comprises a set of longitudinal and/or lateral support rods. In another embodiment, a grate extension comprises a set of longitudinal and/or lateral support rods. In these embodiments, support rods may form a grid pattern and a plurality of grid openings that allow liquids and/or certain debris (depending on the size of the debris relative to the grid opening) to flow through the primary grate and/or grate extension. In these embodiments, support rods may provide a contact surface for kitchenware placed on a sink grate to keep the kitchenware from contacting a bottom of a sink surface. In another embodiment, a primary grate comprises an outer rail and at least some support rods are connected to or supported by the outer rail. In another embodiment, a grate extension comprises an outer rail and at least some support rods are connected to or supported by the outer rail.

In still another embodiment, a grate extension comprises at least one arm configured to engage with a primary grate (or another grate extension) to connect a grate extension to a primary grate (or another grate extension) and/or allow a primary grate to support a grate extension, and preferably in a configuration that allows a grate extension to be variably positionable relative to the primary grate. In one embodiment, a primary grate comprises at least one guide channel configured to receive an arm on a grate extension. In still another embodiment, there are at least two arms for each grate extension and at least one guide channel for each arm.

In another embodiment, a primary grate comprises an inner rail defining a grate aperture configured to allow access to a sink drain. In one embodiment, a grate aperture is not geometrically centered within the primary grate. In another embodiment, a grate aperture is geometrically centered within the primary grate. In still another embodiment, a grate aperture is around the size of a drain in a sink. In another embodiment, a grate aperture is larger than the size of a drain in a sink. In one embodiment, a grate aperture has an area that is around two times, or around three times, or around four times or more larger than an area of a sink drain. In one embodiment, a grate aperture comprises an unobstructed opening allowing access to a sink drain and/or under a portion of a sink grate system.

In one preferred embodiment, a location of a grate aperture relative to a sink drain for a sink in which a sink grate system is used is selectively positionable. In one embodiment, a location of a grate aperture is selectively positionable by selectively changing a position and/or degree of extension of one or more grate extensions relative to a primary grate. In another embodiment, a location of a grate aperture is selectively positionable by selectively by rotating the primary grate and any connected grate extension relative to the sink. In still another embodiment, a location of a grate aperture is selectively positionable a combination thereof.

In another preferred embodiment, a size of a grate aperture may be selectively changed by changing a position of one or more grate extensions relative to the grate aperture so that a portion of the one or more grate extensions partially or fully covers over the grate aperture to reduce a size of an unobstructed portion or the grate aperture. In one embodiment, one or more grate extensions comprise a solid portion that obstructs or blocks fluids and/or debris from flowing through the solid portion and the solid portion is alignable with a portion of the grate aperture to reduce a size of the grate aperture by obstructing part of the grate aperture. In another embodiment, one or more grate extensions comprise a grid portion that allows fluids and/or debris (depending on the size of the debris relative to a grid opening) to flow through grid openings while blocking larger debris and/or supporting kitchenware and the grid portion is alignable with a portion of the grate aperture to reduce a size of the grate aperture that is unobstructed.

In another preferred embodiment, a sink grate system comprises a primary grate with a grate aperture and a drain guard. In one embodiment, a drain guard is selectively positionable to alter a size and/or location of an unobstructed portion of a grate aperture. In one embodiment, a drain guard is configured to selectively obstruct at least a portion of a grate aperture in a primary grate. In one embodiment, a drain guard comprises a solid portion that obstructs or blocks fluids and/or debris from flowing through the solid portion and the solid portion is alignable with a portion of the grate aperture to reduce a size of the grate aperture by obstructing part of the grate aperture. In another embodiment, a drain guard comprises a grid portion that allows fluids and/or debris (depending on the size of the debris relative to a grid opening) to flow through grid openings while blocking larger debris and/or supporting kitchenware and the grid portion is alignable with a portion of the grate aperture to reduce a size of the grate aperture that is unobstructed. In still other embodiments, a drain guard comprises a guard opening surrounded or at least partially surrounded by a solid portion and/or a grid portion and the guard opening provides an unobstructed passage through the drain guard and through an aligned portion of a grate opening in a primary grate.

In one preferred embodiment, a drain guard is removable from a primary grate. In another embodiment, a drain guard is selectively rotatable relative to a grate aperture to align a guard opening in the drain guard with a sink drain through the grate aperture. In one embodiment, a drain guard is removable from a primary grate and selectively positionable in one of multiple positions relative to a grate aperture to align a guard opening in the drain guard with a sink drain through the grate aperture. In still another embodiment, a removable drain guard is configured to fit into and partially span a grate aperture and leaves a portion of the grate aperture unobstructed, preferably to align with a drain in a sink in which the system is positioned.

In another embodiment, a sink grate system comprises a primary grate, a single grate extension, and a drain guard. In still another embodiment, a sink grate system comprises a primary grate, two or more grate extensions, and a drain guard. In still another embodiment, a sink grate system comprises a primary grate, at least one grate extension configured to extend laterally from the primary grate, at least one grate extension configured to extend longitudinally from the primary grate, and a drain guard.

In another preferred embodiment, a primary grate comprises feet that contact a sink bottom in use and elevate other portions of the primary grate and any connected grate extension and/or drain guard from contacting the sink bottom. In another embodiment, a grate extension also comprises feet that contact a sink bottom. In still another preferred embodiment, a grate extension does not include any feet, but the grate extension is cantilevered from a primary grate when the grate extension is used. In another embodiment, where one grate extension is provided to connect to another grate extension, additional feet are provided on one or both of the grate extensions. In still another embodiment, a sink system comprises a covering for all feet to protect a surface of a sink bottom and/or aid in prevent the sink system from sliding on a sink bottom surface.

Sink grate systems according to embodiments herein may comprise an assembly of separate components, some of which are optional, that may be configured to selectively adjust a size of a grate used to protect the bottom surface of a sink from damage and to be usable with sinks of different sizes. Sink grate systems according to embodiments herein may aid in protecting a bottom of a sink while not interfering with access to a drain in the sink. Sink grate systems according to embodiments herein may also be configured to adjust a location of a grate aperture, or an unobstructed portion of a grate aperture, relative to a sink drain location to allow alignment of a grate aperture, or an unobstructed portion thereof, with a sink drain in various sinks having different drain configurations. Sink grate systems according to embodiments herein may also be configured to selectively adjust a size of a grate aperture (or a size of an unobstructed portion of a grate aperture) by partially obstructing the grate aperture to further allow for use with sinks of different configurations, while reducing the likelihood that objects will fall through the grate aperture into the drain.

The foregoing description has outlined some of the more pertinent features of disclosed sink grate systems. These features should be construed to be merely illustrative.

### BRIEF DESCRIPTION OF THE DRAWINGS

For a more complete understanding of the present disclosure and so that the manner in which the features and advantages of embodiments herein, including preferred embodiments, can be understood in more detail, reference is now made to the following brief description, taken in connection with the accompanying drawings and detailed description.

FIG. 1A depicts a top view of a sink grate system according to an embodiment of this disclosure;

FIG. 1B depicts a side view of the sink grate system of FIG. 1A;

FIG. 2 depicts an exploded isometric view of the sink grate system of FIG. 1A;

FIG. 3A depicts a top view of a primary grate according to an embodiment of this disclosure;

FIG. 3B depicts a side view of the primary grate of FIG. 3A;

FIG. 3C depicts a top view of the primary grate of FIG. 3A with a grate extension attached in a fully inserted position;

FIG. 4 depicts an isometric view of the primary grate of FIG. 3A;

FIG. 5A depicts a top view of a grate extension according to an embodiment of this disclosure;

FIG. 5B depicts a side view of the grate extension of FIG. 5A;

FIG. 6 depicts an isometric view of the grate extension of FIG. 5A;

FIG. 7A depicts a top view of a drain guard according to an embodiment of this disclosure;

FIG. 7B depicts a sectional view of the drain guard of FIG. 7A;

FIG. 8 depicts an isometric view of the drain guard of FIG. 7A;

FIG. 9A depicts a top view of the sink grate system of FIG. 1A with an open portion of the drain guard at a rear center position of a primary grate;

FIG. 9B depicts a top view of the sink grate system of FIG. 1A with the open portion of the drain guard at a rear right position of a primary grate;

FIG. 9C depicts a top view of the sink grate system of FIG. 1A with the open portion of the drain guard at a center position of a primary grate; and

FIG. 9D depicts a top view of the sink grate system of FIG. 1A with the open portion of the drain guard at a right center position of a primary grate.

### DETAILED DESCRIPTION

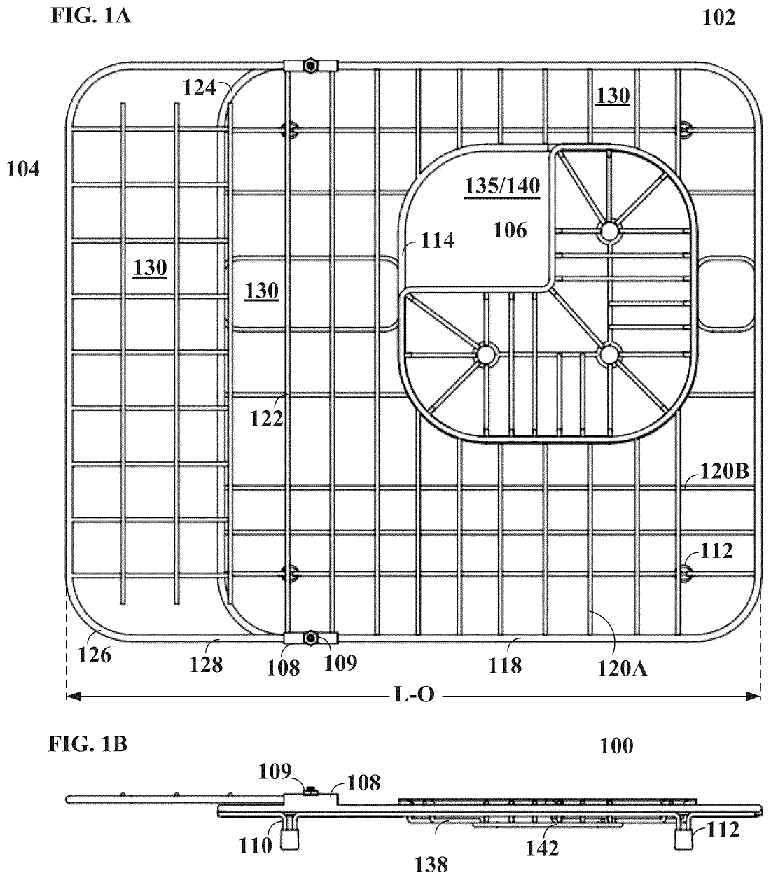

FIGS. 1A-9D depict a sink grate system 100 according to an embodiment of this disclosure. Sink grate system 100 is preferably a “universal” system. The term ‘universal’ refers to the idea that sink grate system 100 provides a user with multiple options for adjusting an orientation and a size of sink grate system 100 to allow for use with various sinks that are pre-existing and/or commercially available, sinks of different sizes and/or different drain configurations, and without requiring any special sink configuration to allow for use of sink grate system 100.

In one preferred embodiment, sink grate system 100 comprises a (1) primary grate 102 and either (2)(a) a grate extension 104 or (2)(b) a drain guard 106. In another embodiment, such as depicted in FIGS. 1A-1B, 2, and 9A-9D, for example, sink grate system 100 comprises primary grate 102, grate extension 104, and drain guard 106. In yet another embodiment, sink grate system 100 comprises primary grate 102 and multiple grate extensions 104, and may optionally comprise drain guard 106.

In one embodiment, primary grate 102 comprises an outer rail 118, or outer ring or outer bar, and a plurality of longitudinal support rods 120A that extend from at least a first side of outer rail 118 to an opposite second side of outer rail 118 (e.g., front to back). Most preferably, a plurality of lateral support rods 120B also extend from a third side of outer rail 118 to an opposite fourth side of outer rail 118 (e.g., left to right) to form a grid across outer rail 118. In one embodiment, an outer end of each support rod 120A and/or 120B is connected to outer rail 118. In another embodiment, both outer ends of at least some support rods 120A and/or 120B are connected to outer rail 118. In still another embodiment, an outer end of each support rod 120B used in primary grate 102 is connected to an underside of outer rail 118 and support rods 120A are disposed to cross on an upper surface of support rods 120B. Ends of each support rod 120A used in primary grate 102 may be connected to a side face or an upper surface of outer rail 118. An opposite configuration or a combination thereof may also be used.

In one embodiment for use with a grate extension 104, primary grate 102 further comprises at least one and preferably at least two guide channels 108. Most preferably, two guide channels 108 are oriented parallel to each other on opposite sides of primary grate 102. If more than one grate extension 104 is being used or included with sink grate system 100, there are preferably at least one and more preferably at least two guide channel 108 for each grate extension 104. Guide channels 108 are not necessary for an embodiment of sink grate system 100 that does not include grate extension 104. When used, each guide channel 108 is disposed on outer rail 118, preferably near a side (e.g., right or left) of outer rail 118, and comprises a hollow tube. A hex nut 109 is preferably connected to each guide channel 108. Each hex nut 109 comprises a threaded interior surface and an aperture that extends through a sidewall of guide channel 108. Each hex nut 109 is configured to receive a set screw 116 and is preferably disposed on a surface of guide channel 108 substantially opposite of outer rail 118. Guide channels 108 may be disposed on an upper or lower surface of outer rail 118. For ease of access for inserting a set screw 116, guide channels 108 are preferably disposed on an upper surface of outer rail 118. As an alternative to guide channel 108, a portion of outer rail 118 may be hollow to receive an arm 132. For example, corners 124 shown near guide channel 108 could be omitted and an end of outer rail 118 (such as in a location under guide channel 108 in the FIGS.) could be hollow to allow insertion of arms 132 without needing a separate guide channel 108. Use of guide channel 108 is preferred over a hollow insertion portion of outer rail 118 when outer rail 118 is made of metal because of corrosion and bacteria/mold issues that may be encountered with a portion of outer rail 118 being hollow and difficulties providing a protective anti-corrosion coating inside a hollow cavity. Guide channel 108 may also be used to connect one grate extension to another grate extension when multiple grate extensions are used with sink grate system 100.

Referring to FIGS. 1A, 3A, and 5A, depending on a length L1 of a first side and/or opposite second side (e.g., front and rear sides) of outer rail 118 on which a guide channel 108 is disposed, and depending on a length L3 of a grate extension 104 to be connected to primary grate 102, a center of each guide channel 108 is preferably spaced a distance L2 from a third side (e.g., a left side) of outer rail 118. Most preferably, L2 is around 14-17% of L1, more preferably around 16-16% of L1, and most preferably around 15.5-15.7% of L1.

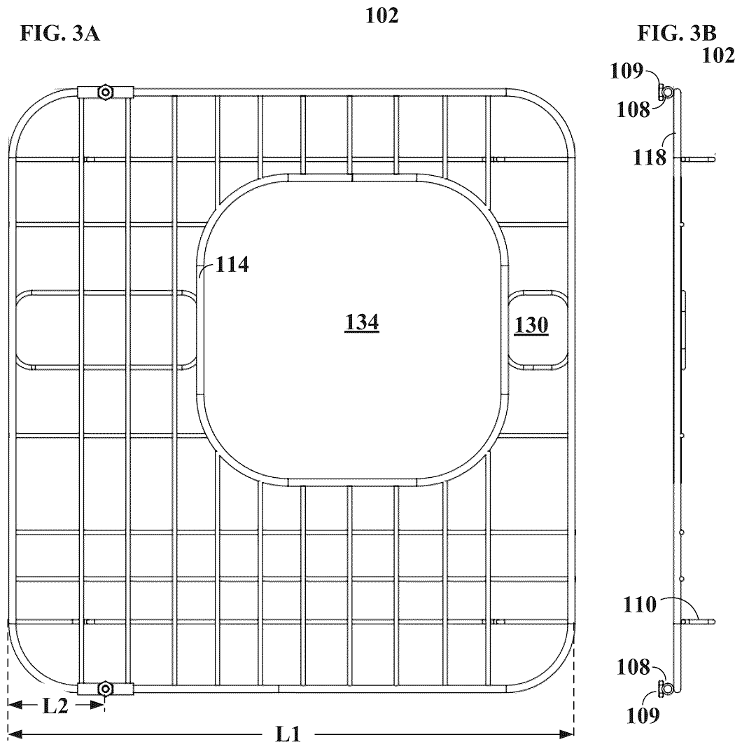

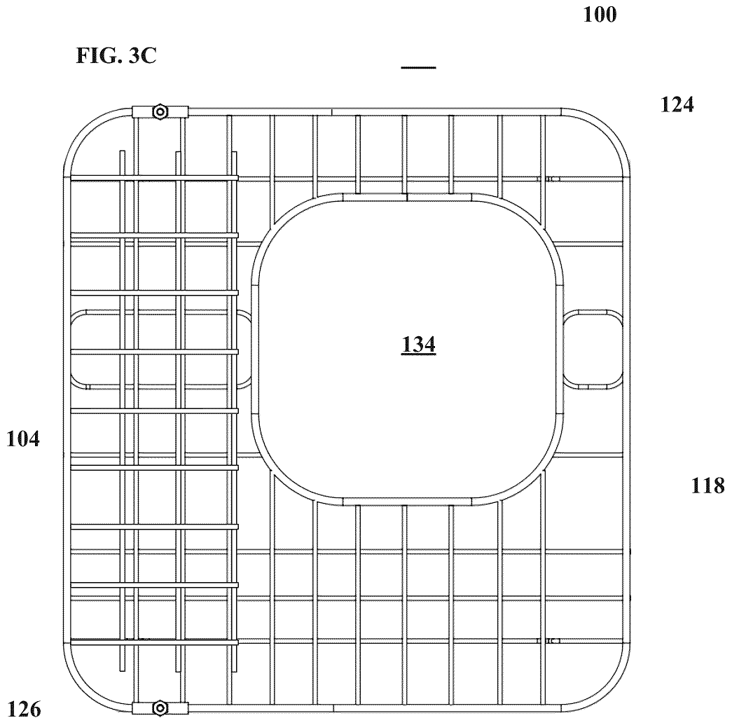

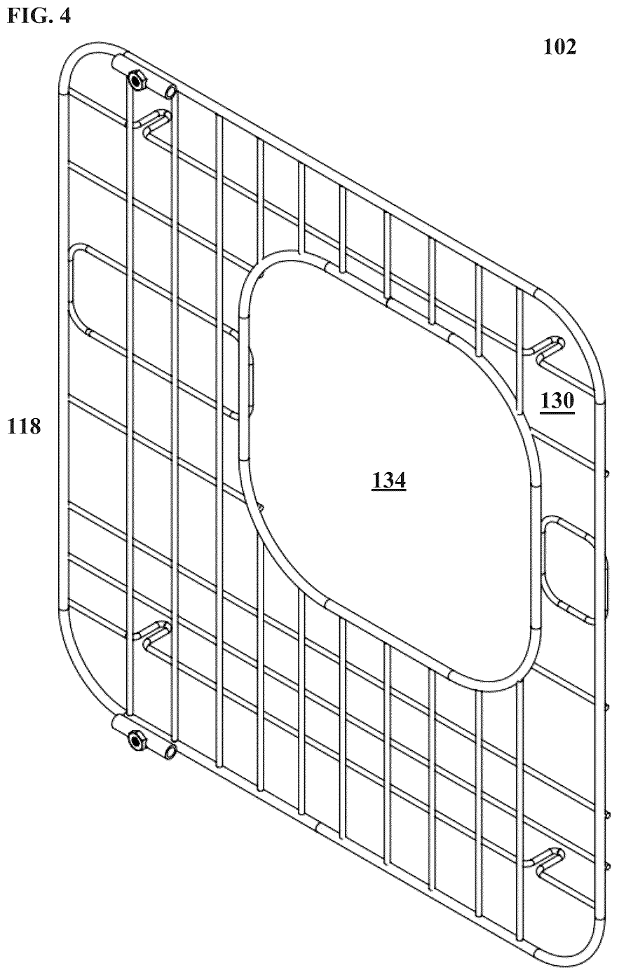

FIG. 3B depicts a side view of primary grate 102 according to an embodiment of this disclosure. Guide channels 108 are shown end-on in this view, indicating where grate extension 104 slidably attaches to primary grate 102 in this embodiment. Although guide channels 108 are shown on only on one side (e.g., the left side) of primary grate 102 in FIGS. 3A-3B, additional grate extensions 104 may be similarly attached to other sides of primary grate 102 using additional guide channels in other embodiments of this disclosure. In addition to grate extension 104 being connectable to a left and/or right side of primary grate 102, additional grate extension(s) 104 may be connectable to a front or rear side of primary grate 102 using additional guide channels 108. To avoid interference between arms 132 of different grate extensions 104, some guide channels 108 may be disposed above outer rail 118 and other guide channels 108 may be disposed below outer rail 118. Such additional grate extensions 104 may be extended in any direction, i.e., laterally (left-right) and/or longitudinally (front-back, or shown as up-down in the orientation of FIG. 1A), to span larger sink bottom surface areas. Additionally, the use of one or more grate extensions 104 in various configurations with primary grate 102 provides added flexibility in locating grate aperture 134 (discussed below) to better align with a drain opening in a sink with which sink grate system 100 is used. This is useful in both fixed grate aperture size and adjustable grate aperture size embodiments discussed herein.

In one embodiment, a primary grate 102 further comprises an inner rail 114 defining grate aperture 134 to allow access to a sink drain. In some embodiments, referred to herein as fixed grate aperture size embodiments, inner rail 114 and grate aperture 134 may be configured for use without any adjustability in a size of an opening (or size of an unobstructed opening) of grate aperture 134. In fixed grate aperture size embodiments, a position of grate aperture 134 relative to a sink drain may be adjustable by the use of one or more grate extensions 104 with primary grate 102 in various configurations to shift a position of grate aperture 134 relative to a sink. However, grate extension(s) 104 are not configured to partially cover or obstruct a portion of grate aperture 134 and sink grate system 100 does not include any other components (such as a drain guard 106) to alter a size of grate aperture 134 by partially or fully obstructing grate aperture 134 in these embodiments.

In other embodiments, referred to herein as adjustable grate aperture size embodiments, a size of grate aperture 134 (or size of an unobstructed opening in grate aperture 134) may be adjusted. In one embodiment, inner rail 114 and grate aperture 134 may be configured for use with a selectively positionable drain guard 106 to at least partially block a portion of grate aperture 134 to effectively reduce an overall size of an opening portion of grate aperture 134 to only a portion 135. In another embodiment, one or more grate extensions 104 are configured to partially cover or obstruct a portion of grate aperture 134, thereby reducing a size of an unobstructed opening 135 through grate aperture 134. In this embodiment, it is not necessary to use a drain guard 106, but a drain guard 106 may also be used in conjunction therewith to provide further adjustability. As further described herein, a partially obstructed or blocked portion of grate aperture 134 is covered over by part of drain guard 106 and/or by part of a grate extension 104 leaving an open or unobstructed portion 135, but it is not required that any portion of grate aperture 134 be completed blocked or sealed in an adjustable grate aperture size embodiment. Rather, a portion of drain guard 106 and/or a grate extension 104 that partially blocks grate aperture 134 may comprise a grid pattern with grid openings 130 that allow fluids and some debris to pass through grid openings 130. Alternatively, a portion of drain guard 106 and/or grate extension 104 that partially blocks grate aperture 134 may comprise a solid surface that prevents fluids or debris from passing through the surface. Combinations thereof may also be use in adjustable grate aperture size embodiments.

In either fixed grate aperture size or adjustable grate aperture size embodiments, inner rail 114 is preferably supported by support rods 120A, 120B, and/or 120C. Support rods 120C are similar to support rods 120A, 120B in material and structure, but are preferably shaped differently. In some embodiments, support rods 120A, 120B are substantially straight or linear (with an exception for an area of a support rod 120A or 120B that may contain a U-shaped foot 110, described further below). In other embodiments, some support rods 120C are bent into a substantially square or rectangular shape to support inner rail 114. Preferably, support rods 120C are unitarily formed from a single piece of metal or singularly molded component. Alternatively, support rod 120C may comprise multiple components that are connected together. Support rods 120C may also be used on grate extension 104 in place of one or more of support rods 120A or 120B and may also be used in other locations on primary grate 102 than those supporting inner rail 114.

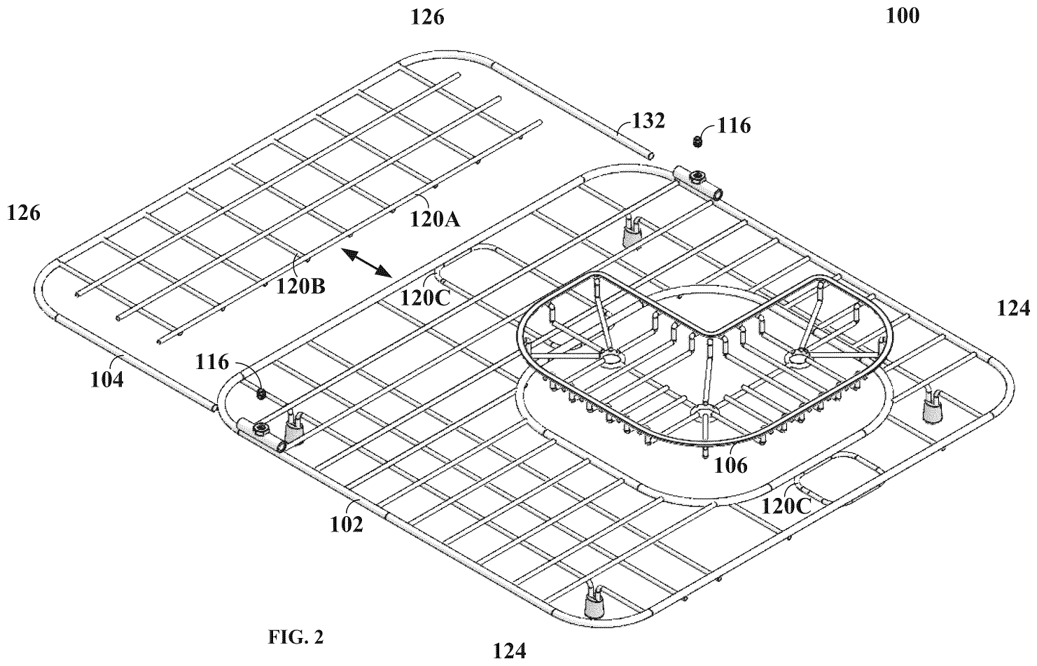

Additionally, in an embodiment with grate aperture 134, some support rods 120A, 120B on primary grate 102 do not extend from one side of outer rail 118 to an opposite side of outer rail 118, but extend from outer rail 118 to a side of inner rail 114 as shown in FIGS. 1A and 2. In one embodiment, ends of each support rod 120B are connected to an underside of outer rail 118 or an underside of inner rail 114 and each support rod 120A is disposed to cross on an upper surface of support rods 120B. Ends of each support rod 120A may be connected to a side face or an upper surface of outer rail 118 or inner rail 114. An opposite configuration for support rods 120A and support rods 120B or a combination thereof may also be used.

In one embodiment, sink grate system 100 may further comprise removable drain guard 106 configured to be received in and to fully fill grate aperture 134, and to be supported by inner rail 114. This embodiment provides a grate that may be inserted into sink grate system 100 to selectively cover over a sink drain when desired and then removed to allow access to the sink drain opening through grate aperture 134, such as for using a tool to push food through the drain opening to a disposal system. Such a drain guard 106 for use in this embodiment is similar to removable drain guard 106 as shown (described further below) but would have a full grid to cover grate aperture 134, rather than a partial grid with an guard opening 140.

FIG. 1B depicts a side view of sink grate system 100 according to an embodiment of this disclosure. This view indicates that sink grate system 100 components (primary grate 102, optional grate extension 104, and optional drain guard 106) are all substantially coplanar when assembled, apart from instances of feet 110 and foot covers 112 described below. Most preferably, sink grate system 100 comprises no springs or hinges.

FIG. 1B also more clearly shows a preferred sliding relationship between primary grate 102 and grate extension 104, via guide channels 108. That is, grate extension 104 may be laterally coincident with primary grate 102. As shown in FIG. 1A, grate extension 104 is in a fully laterally extended position according to one embodiment. In this fully extended position, a support rod 120A distal from a closed end of outer rail 128 is preferably positioned over a first end (e.g., a left end) of outer rail 118 or interiorly of a first end of outer rail 118 to provide added support for grate extension 104. In an alternate embodiment, a support rod 120A distal from a closed end of outer rail 128 may positioned to not overlap a first end (e.g., a left end) of outer rail 118, such that it remains on an exterior of a first end of outer rail 118 when in a fully extended position. Additionally, in a fully extended position for either embodiment, a distal end of each arm 132 extends beyond an aperture in guide channels 108 so that set screw 116 can make contact with arm 132, and are each preferably positioned at least half way or more between an aperture in guide channel 108 and a distal end of guide channel 108 (e.g., an end opposite from an insertion end).

As shown in FIGS. 1A and 2, a preferred embodiment of a primary grate 102 is substantially rectangular, as most sinks are rectangular. However, other shapes can also be used, such as square or rounded or circular, to substantially correspond to a shape of a sink with which primary grate 102 will be used. Outer rail 118 preferably has corners 124 that are rounded to avoid damaging a surface of a sink with which primary grate 102 is being used. Outer rail 128 of grate extension 104 also preferably has outer corners 126 that are rounded to avoid damaging a surface of a sink with which grate extension 104 is being used.

In another embodiment, primary grate 102 may further comprise support feet 110. Feet 110 are preferably disposed near an outer perimeter of primary grate 102 to elevate outer rail 118 and support rods 120A or 120B to avoid them having contact with a bottom surface of a sink. In some embodiments, each foot 110 may be disposed on a support rod 120B or support rod 120A disposed closest to outer rail 118 near corners of outer rail 118. In some embodiments, each foot 110 may be disposed on or near a cross point 122 between a support rod 120B and a support rod 120A, preferably that are both disposed closest to outer rail 118 near a corner of outer rail 118, as shown in FIG. 1B. In a preferred embodiment as shown in FIGS. 1B, 2, and 4, there may be four feet 110 disposed near outer corners of primary grate 102, but as few as three feet 110 may suffice. In another embodiment, feet 110 may be disposed on outer rail 118, preferably near corners 124.

Each foot 110 may comprise a U-shaped structure extending downwardly from an upper surface of primary grate 102. In one embodiment, each foot 110 may be inexpensively manufactured by bending a support rod 120A or 120B as shown to form a U-shaped structure. Alternatively, feet 110 may be separate devices that are attached to a support rod 120A or 120B or attached to outer rail 118 or a combination thereof. Preferably, there are three to four feet 110 to support primary grate 102; however, additional feet 110 may be used depending on a length L1 and a width (measured in a direction substantially perpendicular to L1) of primary grate 102. Similar feet 110 may be provided on grate extension 104 in some embodiments. In a preferred embodiment, it is not necessary to use any feet 110 on grate extension 104 as grate extension 104 is adequately supported by arms 132 and guide channels 108 to keep grate extension 104 in a cantilevered, elevated position relative to a bottom surface of a sink.

Each foot 110 may be provided with a foot cover 112 as shown in FIGS. 1A, 1B, and 2. Each foot cover 112 may comprise a cap made of an elastomeric material, such as rubber or a synthetic equivalent. Such pliable materials are capable of both flexibly fitting and gripping around a corresponding foot 110, and of preventing such foot 110 from directly contacting a bottom surface of a sink and causing damage to the bottom surface or a coating on such a bottom surface, even if sink grate system 100 is rather heavily loaded with kitchenware.

FIG. 2 depicts an exploded isometric view of sink grate system 100 according to an embodiment of this disclosure. This figure shows set screws 116, which each fit into a hex nut 109 and a corresponding guide channel 108 and may be tightened to secure grate extension 104 in fully inserted (smallest size), fully extended (largest size), or any intermediate position in between relative to primary grate 102. In the embodiment shown, set screws 116 comprise Allen screws, which may be tightened and loosened with a separate Allen wrench (not shown), which are familiar to those of ordinary skill. One advantage of Allen screws is that they do not protrude upward as regular bolts would, so there is less likelihood of kitchenware (or other materials that might be placed in a sink) being damaged when placed upon sink grate system 100. However, other known mechanisms for tightening grate extension 104 into a particular position with respect to primary grate 102, including bolts, are also within the scope of this disclosure.

FIG. 3A depicts a top view of primary grate 102 according to an embodiment of this disclosure. FIG. 3B depicts a side view of primary grate 102 according to an embodiment of this disclosure. FIGS. 3B and 4 illustrate feet 110 without any foot cover 112 elements.

FIG. 3C depicts a top view of primary grate 102 of FIG. 3A with grate extension 104 attached in a fully inserted position according to one preferred embodiment. In this preferred embodiment, a closed end of outer rail 128 aligns with a portion of outer rail 118 so that a length of primary grate 102 is not extended by 104. Once a grate extension 104 has been inserted into a primary grate 102, a user may elect to not extend grate extension 104 (to leave it in a fully inserted position) if primary grate 102 adequately covers a sink bottom; removal of any installed grate extensions 104 in such situations is therefore not required. Sink grate system 100 may be used with only primary grate 102 for sinks of certain lengths (e.g., left to right measurement) or may be used with both primary grate 102 and one or more grate extensions 104 connected in a lateral manner for sinks with longer lengths. Sink grate system 100 may also be used with primary grate 102 and one or more grate extensions 104 connected in a longitudinal manner for sinks of certain widths (e.g., front to back measurement, such as a commercial sink or a laboratory sink).

In another embodiment, when a grate extension 104 is fully inserted into primary grate 102, a portion of grate extension 104 does extend beyond outer rail 118 to provide some added length or width to primary grate 102. In this embodiment, it may be necessary to remove an installed grate extension 104 if dimensions of primary grate 102 alone will adequately cover a sink bottom.

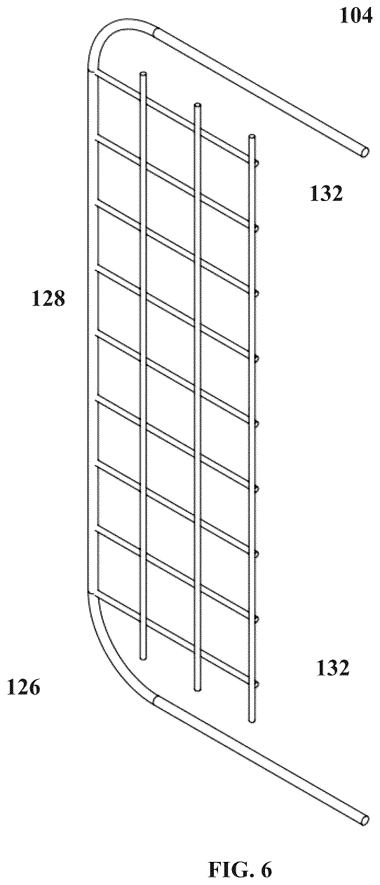

FIG. 4 depicts an isometric view of primary grate 102 of FIG. 3A. This view may denote the configuration of primary grate 102 when placed upright into a dishwasher, for example. Primary grate 102 is preferably made of materials that are dishwasher-safe. Grate extension 104 and drain guard 106, shown separately in similar orientations in FIGS. 6 and 8, are also preferably dishwasher-safe.

In one embodiment, grate extension 104 comprises a substantially U-shaped outer rail 128 and a plurality of support rods 120B. Outer rail 128 comprises a closed end and a pair of extending arms 132 that form an open end of outer rail 128. Each arm 132 is configured to be inserted into a guide channel 108 to selectively position grate extension 104 relative to primary grate 102 to extend an overall length L-O of sink grate system 100 formed by primary grate 102 and grate extension 104 to fit within a sink. As shown by a double sided arrow in FIG. 2 between primary grate 102 and grate extension 104, grate extension 104 is slidably connectable to primary grate 102 by inserting each arm 132 into a corresponding guide channel 108 to an extent necessary to achieve a desired overall length L-O. An overall length L-O for use of sink grate system 100 with both primary grate 102 and grate extension 104 is preferably slightly shorter than a dimension (e.g., a length left to right) of a sink with which sink grate system 100 is to be used, to keep outer rail 118 and outer rail 128 from contacting sidewalls of the sink during use of the sink with sink grate system 100.

An overall variable length L-O of primary grate 102 and grate extension 104 (as shown in FIG. 1A) is preferably around 65-83% of a combined length of L1 plus L3, more preferably around 68-80% of a combined length of L1 plus L3. This adjustability in overall variable length L-O of primary grate 102 coupled with grate extension 104 allows sink grate system 100 to be used with many different sinks having various lengths. Once arms 132 are inserted into guide channels 108 to position grate extension 104 relative to primary grate 102 to achieve a desired overall length L-O, a set screw 116 may be inserted through an aperture in each guide channel 108 and tightened down to contact an outer surface of arm 132 disposed within guide channel 108, to secure grate extension 104 in an extendable position relative to primary grate 102. Although it is preferred to use set screws 116 to secure arms 132 in guide channels 108 to keep grate extension 104 from moving relative to primary grate 102 during use of a sink, which could shorten the L-O or overly extend grate extension 104 so that its closed end makes unnecessary contact with a sidewall of a sink, it is not necessary to do so, and set screws 116 and an aperture in guide channels 108 to receive a set screw 116 may be omitted from sink grate system 100.

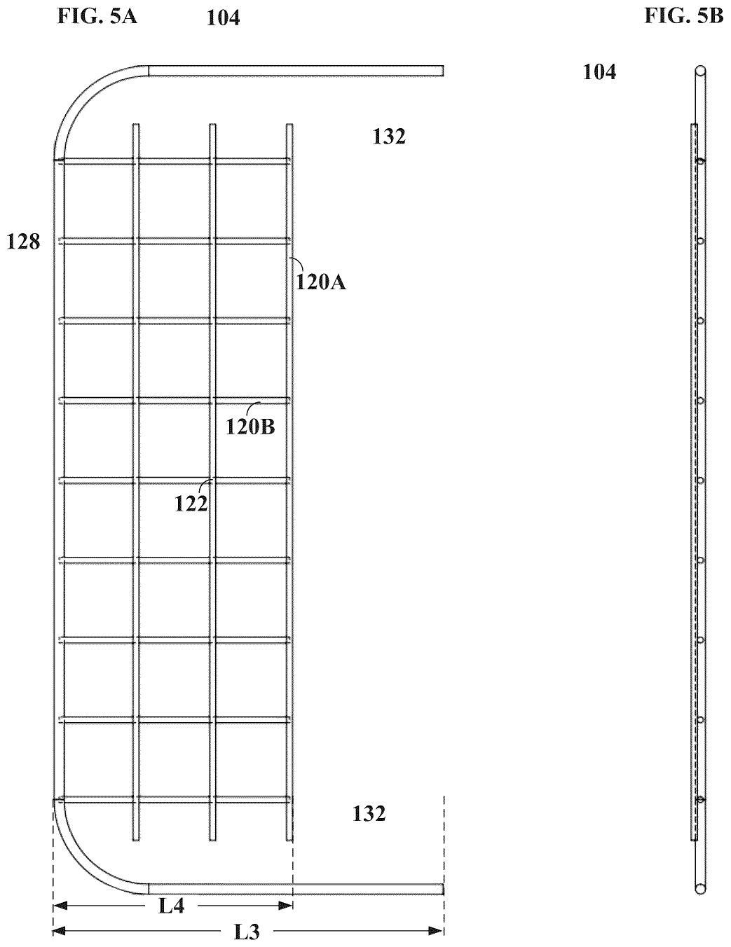

Support rods 120B used in grate extension 104 extend from a closed side of outer rail 128 toward an open side of outer rail 128 (e.g., left to right). Most preferably, support rods 120B on grate extension 104 do not extend out to a full length of arms 132 or a full length L3 of a side of grate extension 104. As shown in FIG. 5A, most preferably, a length L4 of support rods 120B is around 50-80%, more preferably around 65-78%, most preferably around 70-75% of L3. A plurality of support rods 120A on grate extension 104 may also extend between sides of outer rail 128 formed by arms 132. In one embodiment, one or more support rods 120A on grate extension 104 extend all the way across grate extension 104 and connect to outer rail 128, similar to support rods 120A on outer rail 118 of primary grate 102. In another embodiment, one or more support rods 120A on grate extension 104 do not connect with at least one arm 132 and most preferably do not connect with either of arms 132. In this embodiment, ends of support rods 120A on grate extension 104 are free floating. At least one end of each support rod 120B or 120A on grate extension 104 is connected to outer rail 128 to provide support. In one embodiment, one outer end of each support rod 120B used on grate extension 104 is connected to an underside of outer rail 128, and support rods 120A are disposed to cross on an upper surface of support rods 120B. An opposite configuration for support rods 120A and support rods 120B may also be used. Additionally, one outer end of each support rod 120B used on grate extension 104 may be connected to a side surface of outer rail 128. Most preferably, a support rod 120A is disposed to cross at an opposite end of each support rod 120B (opposite from an end connected to outer rail 128). Most preferably, support rods 120B on grate extension 104 are shorter than support rods 120A on grate extension 104.

One or more cross points 122 where a support rod 120A crosses a support rod 120B in either primary grate 102 or grate extension 104 may also be connected together. Alternatively, a support rod 120A or 120B may simply rest upon an oppositely direct support rod 120B or 120A without being connected together; however, it is preferred that at least some cross points 122 are connected together to provide additional support and rigidity to primary grate 102 and/or grate extension 104. A grid pattern formed by support rods 120A and 120B in primary grate 102 or grate extension 104 may comprise grid openings 130 that are uniformly sized and spaced apart, or grid openings 130 may comprise a plurality of different sizes and shapes, or a combination thereof. A grid pattern formed by support rods 120A and 120B may be substantially rectangular or other shapes may also be used. In some embodiments, a first set of grid openings 130 in grate extension 104 are uniformly sized and spaced apart but sized differently from one or more other sets of grid openings 130 in primary grate 102. In an embodiment as shown in FIG. 1A, the various support rods 120A run up-down and support rods 120B run left-right as shown to form a substantially perpendicular grid structure, but other arrangements of support rods are also within the scope of this disclosure. Grid openings 130 are preferably sized and shaped to decrease the likelihood that an eating utensil (e.g., a knife, fork, spoon, etc.), a tilted dish or plate or pot lid, or other item of kitchenware could fall through sink grate system 100 and cause damage to the sink or slip into a sink drain, while also allowing liquid and at least some debris (such as food debris) to flow through to the sink drain without being blocked by sink grate system 100.

FIG. 5B depicts a side view of grate extension 104 of FIG. 5A. Grate extension 104 is substantially planar, to slide over primary grate 102 to adjust an overall length of sink grate system 100, in one embodiment. Embodiments having multiple grate extensions 104 enable adjustment of both an overall length and an overall length of sink grate system 100.

FIG. 6 depicts an isometric view of grate extension 104 of FIG. 5A. This view corresponds to FIG. 1A for an embodiment of sink grate system 100 comprising at least primary grate 102 and grate extension 104. Embodiments may further comprise drain guard 106 as shown in a similarly oriented view in FIG. 8.

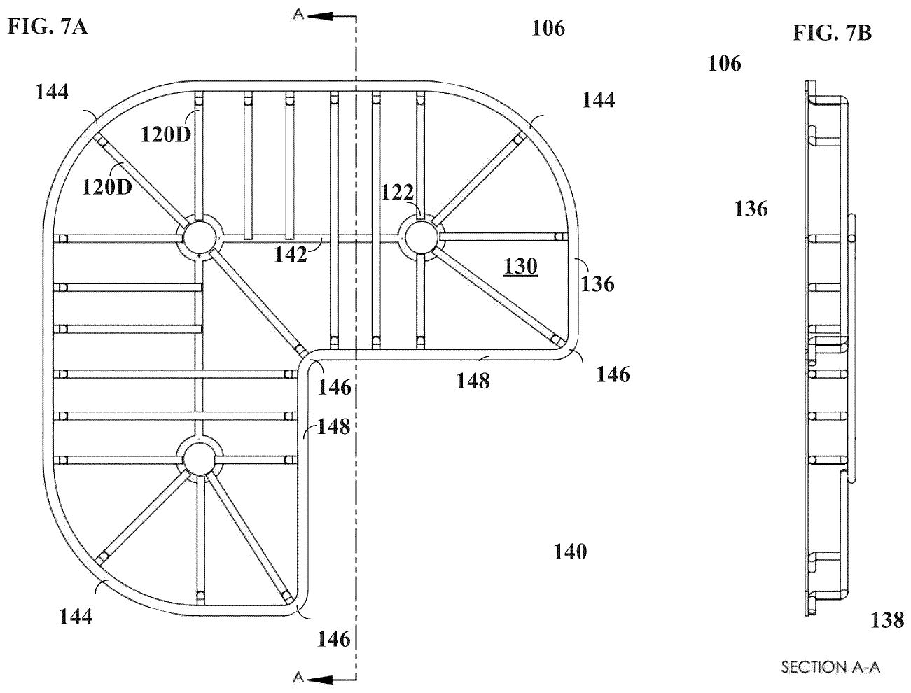

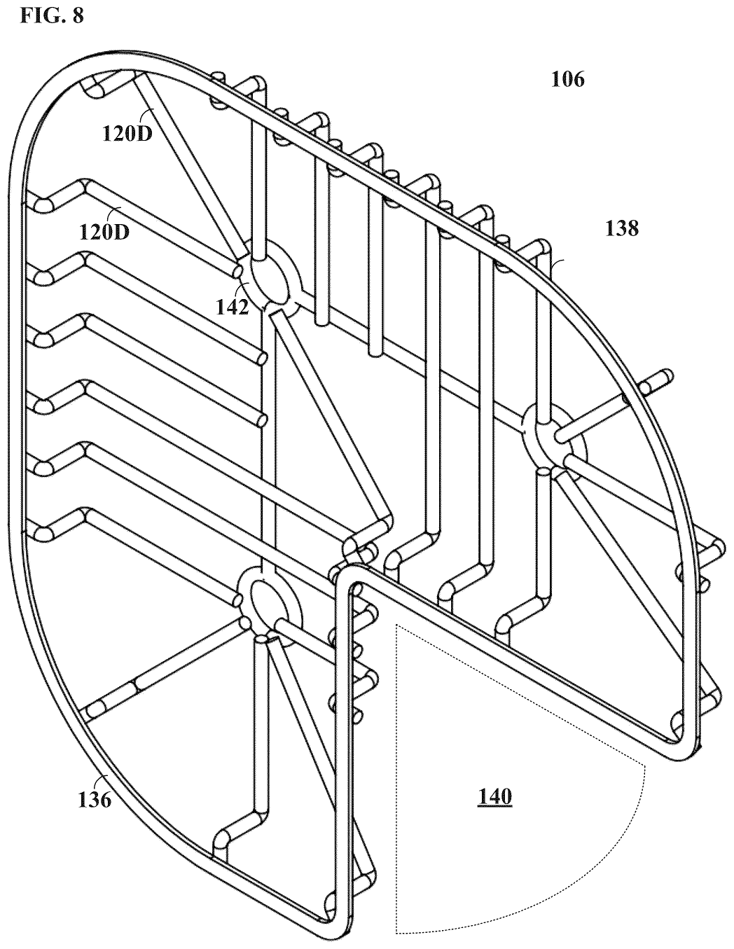

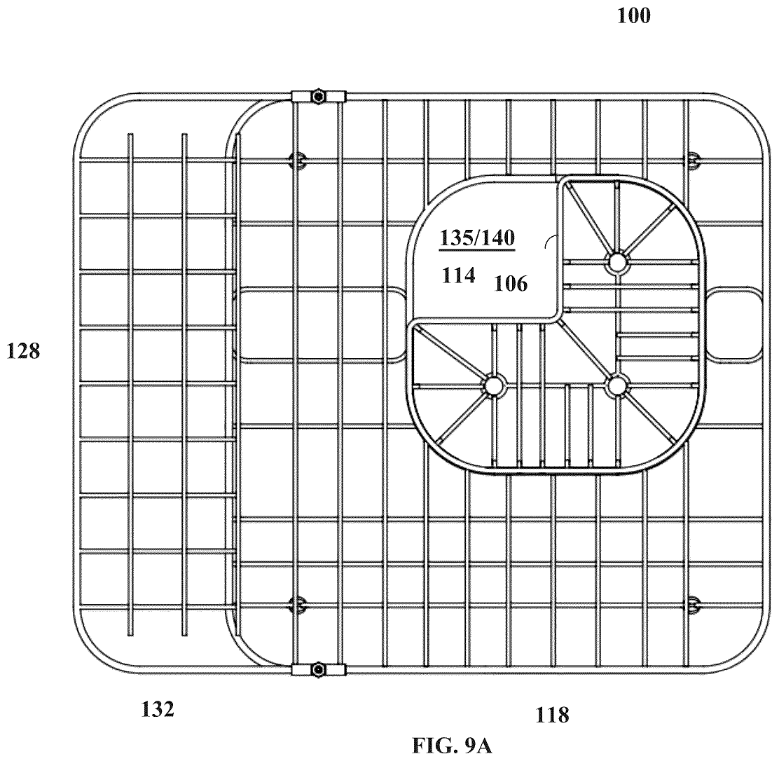

Referring to FIG. 7A, sink grate system 100 preferably further comprises a selectively positionable drain guard 106 to allow use with sinks having varying drain locations. This embodiment enables a user to access a sink drain through a selectively positionable unobstructed portion 135 of grate aperture 134 in sink grate system 100 as shown in FIG. 1A while protecting the rest of a bottom surface of a sink. This allows use of sink grate system 100 in sinks having different drain locations, including locations other than a geometric center of a bottom surface of a sink. A drain guard 106 may be used with primary grate 102 alone or may be used with a combination of primary grate 102 and one or more grate extensions 104.

Embodiments of grate aperture 134 defined by inner rail 114, and a portion 135 of grate aperture 134 defined by guard opening 140 in removable and repositionable drain guard 106 are shown in FIGS. 1A, 3A-3C, and 9A-9D. In one embodiment, such as shown in FIGS. 7A-7B and 8, a drain guard 106 comprises an outer rail 136 and a body 138 disposed inwardly from outer rail 136. Outer rail 136 is preferably configured to rest on or engage with or be supported by inner rail 114 on primary grate 102.

As shown in FIGS. 7A-7B and 8, outer rail 136 is preferably shaped to correspond to a shape of inner rail 114, except for a missing portion of drain guard 106 that forms a guard opening 140 disposed between sides 148. Outer rail 136 preferably forms a substantially L-shaped (as shown) or three-quarter pie (circular) shaped perimeter for drain guard 106. Most preferably, outer rail 136 forms a L-shape with substantially equal length legs (e.g., sides 148), but other configurations may also be used. A non-circular shape for inner rail 114 and drain guard 106 in some embodiments may aid in maintaining drain guard 106 in a desired position as it will not rotate within inner rail 114, but would need to be at least partially removed or lifted up from inner rail 114 then rotated and repositioned into grate aperture 134. For exterior corners 144 of outer rail 136, it is preferred to have a radius, which may aid in forming outer rail 136 from a single piece of material, but more squared shapes or corners with a smaller radius may also be used. In some embodiments, exterior corners 144 are configured to correspond to a size and shape of outer corners on inner rail 114 around grate aperture 134. Inner corners 146 disposed near guard opening 140 are also preferably rounded, but have a smaller radius than exterior corners 144. Rounding of inner corners 146 aids in avoiding sharp corners that could be more prone to failure, breaking of any protective coating on outer rail 136, damaging kitchenware, or injuring a user during placement or rotation of drain guard 106.

Drain guard 106 also preferably comprises a body 138 connected to outer rail 136. Body 138 may be a solid plate or may comprise a grid structure as shown, formed by support rods 120D (similar to a grid formed on primary grate 102 or grate extension 104 by support rods 120A, 120B, and/or 120C) or a similarly perforated or partially open surface. If solid, body 138 is preferably sloped to direct water and food debris towards guard opening 140, which is configured to be alignable with a sink drain as further described herein.

In one embodiment, body 138 extends downwardly from outer rail 136 so that a portion of body 138 can engage with inner rail 114 to hold drain guard 106 in position in primary grate 102, with body 138 disposed through grate aperture 134. It is not necessary for a portion of body 138 to contact inner rail 114 during normal use of sink grate system 100 with drain guard 106, only that body 138 can be inserted into grate aperture 134 with outer rail 136 and/or ends of support rods 120D resting on or supported by inner rail 114 in this embodiment. Any significant lateral movement of drain guard 106 would be blocked by body 138 abutting inner rail 114 in a downwardly extending body 138 embodiment as shown.

FIG. 7B depicts a sectional view of drain guard 106 of FIG. 7A. Drain guard 106 is of limited depth to enable passage of liquids and debris under sink grate system 100 toward a drain when drain guard 106 with a downwardly extending body 138 is used.

Referring to FIG. 8, an isometric view of drain guard 106 of FIG. 7A is depicted. In one embodiment, body 138 is formed by support rods 120D and a support bracket 142 as shown. In one embodiment, support bracket 142 comprises a substantially L-shape component formed by a plurality of rings connected by substantially straight support rods as shown. A ring is preferably disposed at a distal end of each support rod and at a point of connection for each support rod to the other support rod. Use of rings in support bracket 142 provides additional area for some support rods 120D to connect to support bracket 142 from angular positions around exterior corners 144 of outer rail 136. If these rings were not included, then ends of support rods 120D that connect to support bracket 142 from angular positions around exterior corners 144 might overlap, creating a thickened area that may be prone to failure or may be damaging to kitchenware that may contact the thickened area during use of the sink. Other geometric shapes may also be used for this connection point, including squares or triangles in open or solid forms, or a solid circle. Rings or similar structures, or grid openings 130 in drain guard 106, may also be sized to allow insertion of a user's fingers to allow drain guard 106 to be lifted from grate aperture 134 for repositioning, or for removal of drain guard 106 when use of drain guard 106 is not desired.

Support rods 120D preferably extend from one side of outer rail 136 to an opposite side of outer rail 136 or to a portion of support bracket 142. In an embodiment where body 138 extends downwardly, support rods 120D may be bent to extend downwardly from outer rail 136. Most preferably, support rods 120D extend inwardly from outer rail 136 as shown, before extending downwardly in order to reduce a length or width dimension of body 138 so that body 138 can easily fit within grate aperture 134.

In one preferred embodiment, some support rods 120D each connect at a first end to outer rail 136 and extend slightly inwardly, then bend downwardly, then bend again to continue extending inwardly, then bend upwardly, then bend again to extend outwardly to connect at a second end to an opposite side of outer rail 136 from its first end. The support rods 120D that extend from one side of outer rail 136 to another side of outer rail 136 may cross over a portion of support bracket 142 at a cross point 122. A support rod 120D may be connected to support bracket 142 at a cross point 122 or simply rest upon support bracket 142 without being connected together; however, it is preferred that at least some cross points 122 on drain guard 106 are connected together to provide additional support and rigidity to drain guard 106.

In one preferred embodiment, other support rods 120D each connect at a first end to outer rail 136 and extend slightly inwardly, then bend downwardly, then bend again to continue extending inwardly to connect at a second end to support bracket 142. In still another embodiment, an outer end of each support rod 120D that is connected to outer rail 136 is connected to an underside of outer rail 136 and an outer end of each support rod 120D that is connected to support bracket 142 is connected to an upper side of support bracket 142. Alternatively, ends of each support rod 120D used may be connected to a side face or an upper surface of outer rail 136 or a side face or lower surface of support bracket 142. Support rods 120D are preferably each a unitary part that is bent and connected together form body 138; however, separate components connected together may be used to form one or more support rods 120D to allow orientation of components in different directions.

In another embodiment, inner rail 114 is configured with a lip or an L-shaped ledge that is configured to receive and support outer rail 136. In this embodiment, drain guard 106 is retained laterally within inner rail 114 by the lip or ledge, as will be understood by those of ordinary skill. In this embodiment, body 138 may extend downwardly into grate aperture 134 or may be substantially flat or coplanar with outer rail 136.

In one embodiment, a grid pattern with grid openings 130 are formed in body 138 of drain guard 106 between support rods 120D, support bracket 142, and/or outer rail 136. In this configuration, drain guard 106 thus provides protection for an underlying sink bottom against contact with abrasive surfaces of kitchenware or objects falling in the sink for a majority of an area of grate aperture 134. In one preferred embodiment, a grid in body 138 covers approximately three-quarters of an area of grate aperture 134 defined by inner rail 114. This allows for portions of grate aperture 134 that are not aligned with a sink drain opening to be covered by a grid of body 138 while still allowing access to open portion 135 through guard opening 140 in drain guard 106.

When a drain guard 106 is used with sink grate system 100, grate aperture 134 is preferably substantially larger than a size of a typical drain opening in a sink. Additionally, as shown in FIG. 3A, a center of grate aperture 134 is preferably not positioned in alignment with a center of primary grate 102 in one embodiment. Having grate aperture 134 be off-set from a center of primary grate 102 aids in providing adjustability in a location of portion 135 of grate aperture 134 to align with a sink drain. Most preferably, a geometric center of primary grate 102 lies within grate aperture 134, but they are not centrally aligned.

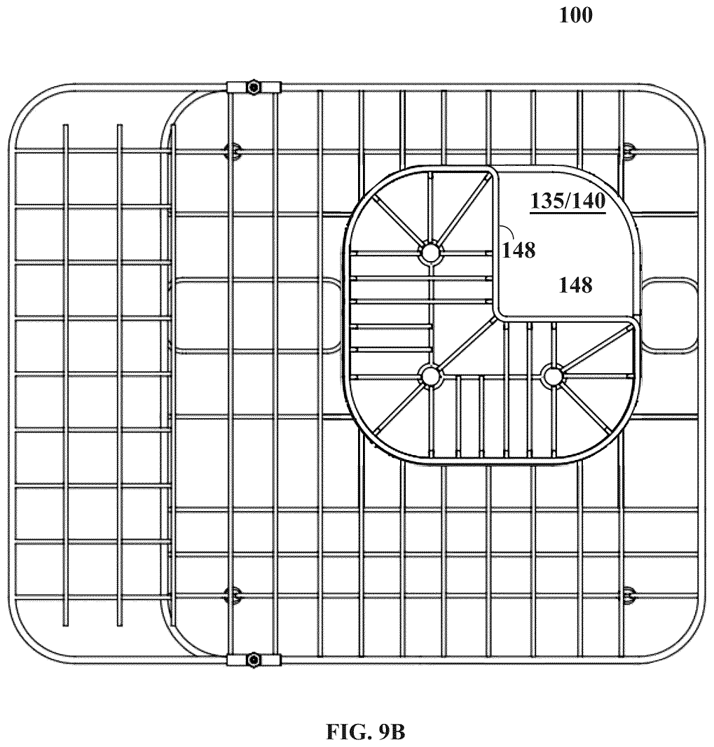

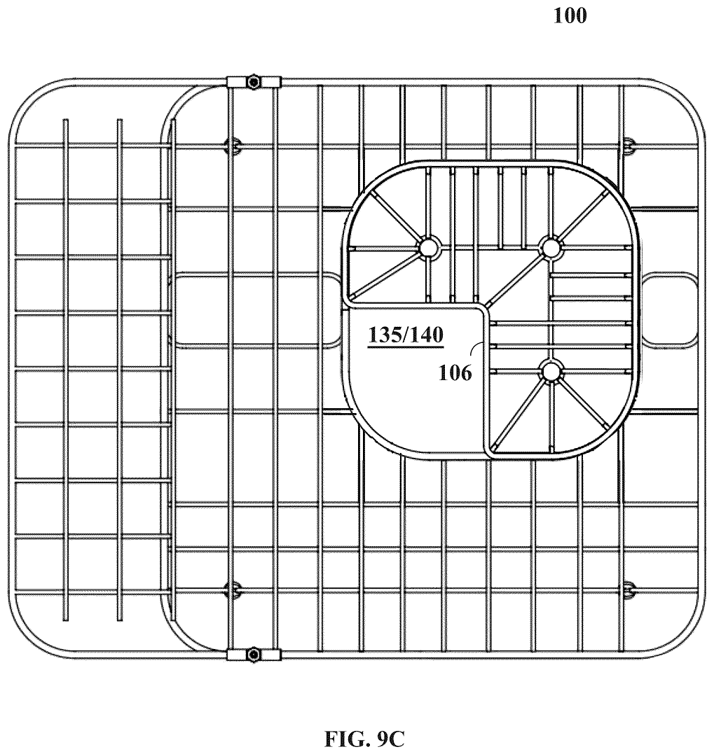

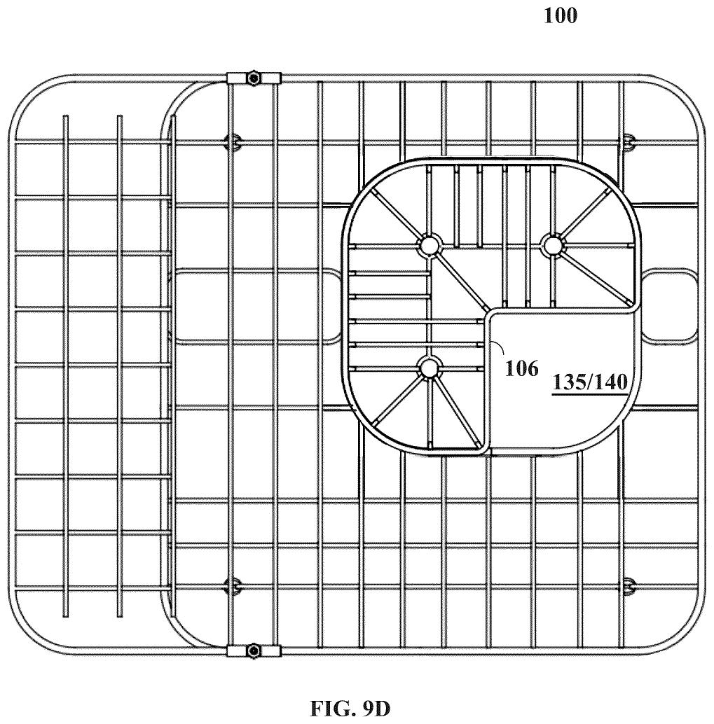

Referring to FIGS. 9A-9D, drain guard 106 is configured to be positioned relative to grate aperture 134 in one of four rotational arrangements, so that guard opening 140 in drain guard 106 aligns with part of grate aperture 134 to form an open, unobstructed portion 135, while body 138 of drain guard 106 covers a remaining part of grate aperture 134 to partially (or fully in some embodiments) obstruct the remaining part of grate aperture 134. Thus, guard opening 140 may be positioned to align open portion 135 with an upper left portion of grate aperture 134 as in FIG. 9A, an upper right portion of grate aperture 134 as in FIG. 9B, a lower left portion of grate aperture 134 as in FIG. 9C, or a lower right portion of grate aperture 134 as in FIG. 9D simply by rotating drain guard 106 relative to grate aperture 134 prior to installation.

This selective rotation of drain guard 106 creates a different location for an open portion 135 of grate aperture 134 to align with a drain in a sink with which sink grate system 100 is to be used. For example, as shown in FIG. 3A, grate aperture 134 is in a location that is substantially to the upper right of primary grate 102 and may be placed in a sink in that positioning. Primary grate 102 may also be rotated +/−90° or by 180° relative to the sink from a position as shown in FIG. 3A for use, which places grate aperture 134 in a different location. For a substantially square embodiment of primary grate 102, grate aperture 134 may be positioned in an upper left, a lower left, or a lower right position relative to primary grate 102 and the sink to provide other configurations for alignment with a sink drain. These configurations are possible in both fixed grate aperture size and adjustable grate aperture size embodiments. When the four positions of a drain guard 106 in an adjustable grate aperture size embodiment, or similar positioning where a portion of grate aperture 134 may be covered by part of a grate extension 104 with or without the use of drain guard 106, then a location of unobstructed open portion 135 may be further adjusted to align with a sink drain. For example, when drain guard 106 is in a position as shown in 9C, open portion 135 is positioned substantially at a geometric center of primary grate 102. If primary grate 102 were rotated counterclockwise 90° from the position shown in FIG. 9D so that grate aperture 134 is at the upper left of primary grate 102 and drain guard 106 were left in the position shown in FIG. 9D, then open portion 135 would be substantially centered in sink grate system 100 as shown. Multiple different configurations to change a location of grate aperture 134 and open portion 135 are possible with preferred embodiments of sink grate system 100.

A choice of an orientation of sink grate system 100 components within a sink determines a location of grate aperture 134 within a sink, and a choice of orientation of drain guard 106 within grate aperture 134 determines a location of open portion 135 within the sink, to allow open portion 135 to be aligned with a sink drain in various locations. A user may thus make both choices to best co-locate open portion 135 with a sink drain, leaving the rest of a bottom surface of the sink, including areas underlying body 138, protected by sink grate system 100.

Open portion 135 allows a user to have direct unobstructed access to a sink drain underlying sink grate system 100. This access may be necessary to remove a stopper from a sink drain, for example, which may have been installed to allow used kitchenware to soak in water and/or a cleaning solution for a time, before later being scrubbed and rinsed. The access may also allow food or other debris to be passed through a sink drain to a disposal system. Sink grate system 100 may therefore be placed into a sink such that open portion 135 aligns with a sink drain when the sink drain is in one of several different positions.

In fixed grate aperture size embodiments, inner rail 114 may be positioned within outer rail 118 to locate grate aperture 134 in a location corresponding to a particular sink drain, without allowing for any adjustability of an opening size of grate aperture 134. In these embodiments, grate aperture 134 may be positioned in any location on primary grate 102, but is preferably centrally located in primary grate 102, or positioned centrally from a first side to a second side but closer to a fourth side (e.g., a rear side) than a third side (e.g., a front side), or positioned centrally between a fourth side (e.g., a rear side) and third side (e.g., a front side) but closer to a second side than a first side. Various locations for grate aperture 134 may be used in these embodiments. In this fixed grate aperture size embodiment, primary grate 102 may be used with grate extension 104 but a selectively positionable drain guard 106 is not needed as grate aperture 134 is not configured to allow for adjustability of its size. A full drain guard (similar to drain guard 106 but without a guard opening 140) may also be used with this embodiment to completely cover a surface of grate aperture 134. A full drain guard in these embodiments may comprise a solid body to prevent direct access to a sink drain or direct access to a bottom surface of a sink through grate aperture 134, including preventing liquids or food or other debris from passing through grate aperture 134. A full drain guard in these embodiments may alternatively comprise a grid pattern (similar to that in drain guard 106 but without guard opening 140) or a plurality of apertures to allow liquid to flow through but to block larger pieces or food or debris from passing through grate aperture 134. In these embodiments, grate aperture 134 is preferably around the same size as a standard residential kitchen sink drain opening, but may be slightly smaller or larger (such as +/−1 inch). Additionally, a location of grate aperture 134 relative to a location of a sink drain may be adjusted even in a fixed grate aperture size embodiment by the use of one or more grate extensions 104 and/or by rotating primary grate 102 relative to the sink.

In one preferred embodiment, a length L4 of a grid portion of a grate extension 104 may span around 4.0-6.0 inches, more preferably 4.5 to 5.5 inches, and most preferably 5.0 inches; a length L1 of primary grate 102 may span around 14.0-16.0 inches, more preferably around 14.5-15.5 inches, and most preferably around 15.75 to 16.0 inches, so an overall length L-O of an extended sink grate system 100 with grate extension 104 is around 18.0 to 22.0 inches, more preferably around 19.00 to 21.50 inches, and most preferably around 19.45 to 19.55 inches. A width (e.g., front to back) of primary grate 102 and/or grate extension 104 is around 15.75 to 16.0 inches to fit most standard sink sizes, but other sizes may also be used to accommodate special sizes of sinks or different types of sinks (such as a residential kitchen sink, commercial/restaurant kitchen sink, or laboratory sink). Additionally, a grate extension 104 may be used in a longitudinally adjustable (e.g., front to back) configuration to increase a width of sink grate system 100 as needed to fit a sink size.

In one preferred adjustable grate aperture size embodiment, grate aperture 134 may be around 7.50 to 8.50 inches, more preferably around 8.10 to 8.37 inches, and most preferably around 8.20 to 8.30 inches in both length and width for a squared shape or in diameter for a circular shape. In this embodiment, grate aperture 134 is substantially larger than a typical size of a sink drain to allow for open portion 135 to more closely fit a typical size of a sink drain when drain guard 106 in inserted into grate aperture 134. In one preferred adjustable grate aperture size embodiment, open portion 135 may be around 3.50 to 3.90 inches, more preferably around 3.65 to 3.85 inches, and most preferably around 3.75 to 3.80 inches in both inner length and inner width (e.g., corresponding to dimensions of sides 148 as shown in FIG. 9B) for a squared shape or in diameter for a circular shape. Outer sides of 135 (e.g., opposite from sides 148) are formed by a portion of inner rail 114, preferably with two substantially linear portions connected by a radius. In one preferred embodiment of selectively positionable drain guard 106, sides 148 may be around 3.50 to 3.90 inches, more preferably around 3.65 to 3.85 inches, and most preferably around 3.75 to 3.80 inches to correspond to a desired size of open portion 135 in grate aperture 134 formed by inner rail 114. A length/width of sides 148 is preferably around 40-60% of a corresponding length/width of drain guard 106, more preferably around 48-52%, and most preferably around 50%. If used, drain guard 106 will be sized so that an outer rail 136 of drain guard 106 and/or an end of one or more support rods 120D is supported by inner rail 114 and body 138 fits within grate aperture 134.

In one embodiment, either a fixed grate aperture size or an adjustable grate aperture size embodiment, a height of sink grate system 100 may be around 0.85 to 1.15 inches, more preferably around 0.95 to 1.12 inches, and most preferably around 1.00 to 1.10 inches. In one embodiment, a vertical distance between a lower end of foot cover 112 (if used) or foot 110 and a lower most portion of body 138 on drain guard 106 may be around 0.45 to 0.70 inches, more preferably around 0.50 to 0.65 inches, and most preferably around 0.55 to 0.63 inches. The height/vertical dimensions in these embodiments provides sufficient clearance to allow most debris passing through grid openings 130 to proceed under sink grate system 100 toward a sink drain when sufficient water or other fluid is present to cause such debris to flow.

Radii of outer corners 126 and corners 124 may be around 1.65 to 1.85 inches, more preferably around 1.70 to 1.80 inches, and most preferably around 1.75 inches. Similarly, radii of the outer corners of an embodiment of inner rail 114 (for a squared shape for inner rail 114 with rounded corners) and exterior corners 144 of drain guard 106 may be around 1.65 to 1.85 inches, more preferably around 1.70 to 1.80 inches, and most preferably around 1.75 inches. Radii of inner corners 146 of drain guard 106 in some embodiments may be around 0.20 to 0.40 inches, more preferably around 0.25 to 0.35 inches, and most preferably around 0.30 inches.

The measurements for these embodiments are merely exemplary, but allow sink grate system 100 to fit within most residential kitchen sinks on the market and provide protection to most if not all of their bottom surface areas.

In some embodiments, one or more of outer rail 118, outer rail 128, inner rail 114, outer rail 136, guide channel 108, support rods 120A, 120B, 120C, 120D, and/or support bracket 142 may each be unitarily formed of a single part or single piece (such as a single piece of metal). In other embodiments, one or more of outer rail 118, outer rail 128, inner rail 114, outer rail 136, guide channel 108, support rods 120A, 120B, 120C, 120D, and/or support bracket 142 may each comprise separate components or parts that are connected together by welding, brazing, soldering, riveting, adhesive, or by a solidly applied outer coating material that covers one or more underlying components or parts. For example, arms 132 may be separate parts from a closed end portion of grate extension 104 or corners 124 may be separate parts from side components of outer rail 118.

In some embodiments, hex nut 109 is preferably connected to each guide channel 108 by forging, welding, brazing, soldering, riveting, or adhesive. Alternatively, an aperture may be formed in a sidewall of each guide channel 108 with a sufficiently thick sidewall to allow an inner surface of the aperture to be threaded to accept a set screw 116, without needing a separate hex nut 109.

In some embodiments, one or more cross points 122 where one support rod 120A, 120B, 120C, and/or 120D crosses another support rod 120A, 120B, 120C, and/or 120D and/or a component of support bracket 142 may also be connected together by welding, brazing, soldering, riveting, adhesive, or by a solidly applied outer coating material that covers one or more underlying components or parts. Alternatively, one support rod 120A, 120B, 120C, and/or 120D may simply rest upon an oppositely or differently directed support rod 120A, 120B, 120C, and/or 120D and/or component of support bracket 142 without being connected together; however, it is preferred that at least some cross points 122 are connected together to provide additional support and rigidity to primary grate 102, grate extension 104, and/or drain guard 106.

In some embodiments, one or more of outer rail 118, outer rail 128, inner rail 114, outer rail 136, support rods 120A, 120B, 120C, 120D, and/or components of support bracket 142 may comprise solid rods or solid cylindrical bodies, may comprise hollow tubes or hollow cylindrical bodies, or may comprise substantially flat bars, or any combination thereof.

In some embodiments, outer ends of each support rod 120A, 120B, 120C, and/or 120D are connected to its corresponding outer rail 118, outer rail 128, inner rail 114, outer rail 136, and/or components of support bracket 142 by welding, brazing, soldering, riveting, adhesive, or by a solidly applied outer coating material that covers an end at its connected rail or support component.

Sink grate system 100 components may also be fabricated from sufficiently durable plastic, wood, or composite materials. Further, although sink grate system 100 components are shown in this disclosure in terms of rails and attached support rods, such as with primary grate 102, sink grate system 100 components may also comprise planar grid structures or substantially flat plates having a large number of drain holes therein.

Components of sink grate system 100, except for foot cover 112, may be made of various metals, plastics, or composite materials. Materials used and configuration of components preferably provide sufficient strength and rigidity to hold the weight of kitchenware resting on a surface of primary grate 102, grate extension 104, and/or drain guard 106 and to maintain an elevated position of sink grate system 100 (other than feet 110 and/or foot cover 112) and kitchenware off of bottom surface of a sink to avoid contact that may damage a bottom surface of a sink.

Metals may include stainless steel, steel, or aluminum alloys. In some embodiments, metal components may be coated with a protective coating layer comprising a plastic or elastomeric material, powder coating, enamel, or plating. Such coatings may deter corrosion of components of sink grate system 100 and/or provide a slight cushioning for kitchenware that comes into contact with sink grate system 100. Components of sink grate system 100 may, for example, be dipped in a liquid elastomer and dried, or sprayed with powder coating paint and baked, as may be readily familiar to one of ordinary skill with the assistance of this disclosure. Such an outer coating may also be used with non-metal embodiments or mixed material embodiments. Any outer coating may be used to provide aesthetic features, such as coloration to match or coordinate with different sink finishes.

Foot cover 112 is preferably made from plastic or elastomeric material to aid in preventing scratching of a bottom surface of a sink (particularly for a sink coated with a color coating or other protective or aesthetic coating) and to provide stability for sink grate system 100 to prevent slippage or sliding along a bottom surface of a sink.

It will be appreciated that a sink grate system and/or a method of using a sink grate system to protect a bottom surface of a sink as disclosed herein may include one or more of the following examples:

Example 1. A sink grate system comprising: a primary grate comprising a first outer rail, a grate aperture, and a first set of support rods; and a grate extension comprising a second outer rail and a second set of support rods; wherein the grate extension is configured to be selectively positionable relative to the primary grate between a first position wherein a first dimension of the sink grate system has a first value and a second position wherein the first dimension of the sink grate system has a second value; and wherein the first value is smaller than the second value.

Example 2. The sink grate system of Example 1 wherein the primary grate further comprises a guide channel configured to receive a portion of the second outer rail to allow the grate extension to selectively slide between the first position and the second position.

Example 3. The sink grate system Example 2 wherein a portion of the primary grate or a portion of the grate extension or both blocks further sliding of the grate extension relative to the primary grate when the grate extension is in the first position.

Example 4. The sink grate system of any one of Examples 2 to 3 wherein the guide channel comprises an aperture configured to receive a fastener to hold the portion of the second outer rail in a selected position.

Example 5. The sink grate system of Example 4 wherein the portion of the second outer rail comprises an arm and wherein a distal end of the arm is disposed to allow the fastener to contact the arm when the selected position is the first position.

Example 6. The sink grate system of any one of Examples 1 to 5 wherein the grate aperture is not geometrically centered in the primary grate and wherein the grate aperture is configured to be alignable with a drain opening in a sink by (1) rotating the primary grate relative to the sink or (2) altering a selected position of the grate extension between the first position and the second position or (3) a combination thereof.

Example 7. The sink grate system of any one of Examples 1 to 6 wherein a first portion of the second set of support rods obstructs a first portion of the grate aperture when the grate extension is in the first position.

Example 8. The sink grate system of Example 7 wherein a second portion of the second set of support rods obstructs a second portion of the grate aperture when the grate extension is in the second position, and wherein the second portion of the grate aperture is smaller than the first portion of the grate aperture.

Example 9. The sink grate system of any one of Examples 1 to 6 wherein no portion of the second set of support rods obstructs the grate aperture when the grate extension is in the second position.

Example 10. The sink grate system of any one of Examples 1 to 9 further comprising a drain guard, wherein the drain guard comprises a third outer rail configured to engage with a portion of the primary grate, a body connected to the third outer rail; and a guard opening; wherein the body and the guard opening are configured to align with the grate aperture; wherein the body at least partially obstructs the grate aperture; wherein the guard opening defines an unobstructed portion of the grate aperture; and wherein the drain guard is selectively positionable relative to the grate aperture to align the unobstructed portion of the grate aperture with a sink drain.

Example 11. The sink grate system of Example 10 wherein the third outer rail surrounds the body; and wherein the guard opening is disposed outside of the third outer rail.

Example 12. The sink grate system of any one of Examples 10 to 11 wherein the third outer rail forms a substantially L-shaped perimeter comprising a first inner leg and a second inner leg; and wherein the guard opening is disposed between the first inner leg and the second inner leg.

Example 13. The sink grate system of any one of Examples 10 to 12 wherein the third outer rail forms at least part of a perimeter of the guard opening.

Example 14. The sink grate system of any one of Examples 10 to 13 wherein the third outer rail surrounds the body and the guard opening.

Example 15. The sink grate system of any one of Examples 10 to 14 wherein the body extends down vertically from the third outer rail and comprises a third set of support rods; wherein the first set of support rods, the second set of support rods, and the third set of support rods each define a plurality of openings that allow liquid to pass through.

Example 16. The sink grate system of any one of Examples 1 to 15 wherein the primary grate further comprises a set of feet that elevate the first set of support rods from contact with a bottom surface of a sink.

Example 17. The sink grate system of any one of Examples 1 to 16 wherein the grate extension is configured to be cantilevered from the primary grate.

Example 18. The sink grate system of any one of Examples 1 to 17 wherein the grate extension is a first grate extension and wherein the sink grate system further comprises a second grate extension.

Example 19. The sink grate system of Example 18 wherein the first grate extension is configured to be selectively positionable laterally relative to the primary grate and the first dimension is a length; wherein the second grate extension is configured to be selectively positionable relative to the primary grate between a third position wherein a second dimension of the sink grate system has a third value and a fourth position wherein the second dimension of the sink grate system has a fourth value; and wherein the third value is smaller than the fourth value.

Example 20. The sink grate system of Example 19 wherein the second dimension is the length and wherein the first grate extension is configured to be selectively positionable relative to a first side of the primary grate and wherein the second grate extension is configured to be selectively positionable relative to a second side of the primary grate substantially opposite the first side.

Example 21. The sink grate system of Example 19 wherein the second dimension is a width.

Example 22. The sink grate system of any one of Examples 1 to 17 wherein there is only one grate extension.

Example 23. The sink grate system of Example 1 to wherein a portion of the primary grate or a portion of the grate extension or both blocks further sliding of the grate extension relative to the primary grate when the grate extension is in the first position.

Example 24. The sink grate system of any one of Examples 1 to 23, wherein the sink grate system contains no springs or hinges.

Example 25. A sink grate system comprising: a primary grate comprising an outer rail, an inner rail defining a grate aperture, and first set of support members forming a first grid; wherein the grate aperture is not positioned in a geometric center of the outer rail of the primary grate; and wherein the primary grate is configured to be selectively rotatable to position the grate aperture in different locations relative to a sink drain.

Example 26. The sink grate system of Example 25, wherein the primary grate is rectangular.

Example 27. The sink grate system of Example 25, wherein the primary grate is circular.

Example 28. The sink grate system of any one of Examples 25 to 27, wherein the first set of support members, the outer rail, and the inner rail are substantially coplanar.

Example 29. The sink grate system of any one of Examples 25 to 28 further comprising a plurality of feet and wherein the sink grate system is configured so that only the plurality of feet contact a bottom of a sink in which the sink grate system is installed.

Example 30. The sink grate system of Example 29, wherein each of the plurality of feet comprise a bent portion of one of the first set of support members.

Example 31. The sink grate system of any one of Examples 29 to 30, wherein each of the plurality of feet further comprises an elastomeric foot cover.

Example 32. The sink grate system of any one of Examples 25 to 31, wherein the sink grate system contains no springs or hinges.

Example 33. The sink grate system of any one of Examples 25 to 32, further comprising: a grate extension that is configured to laterally extend from the primary grate.

Example 34. The sink grate system of any one of Examples 25 to 33, wherein the grate extension is configured to be selectively positionable between a fully inserted position and a fully extended position.

Example 35. The sink grate system of Example 34 wherein the grate extension does not increase a length of the primary grate when in the fully inserted position.

Example 36. The sink grate system of Example 34 wherein the grate extension increases a length of the primary grate by around 25 to 40% when in the fully extended position.

Example 37. The sink grate system of any one of Examples 25 to 36, further comprising: a removable drain guard configured to be alignable with the grate aperture.

Example 38. The sink grate system of Example 37, wherein the removable drain guard comprises a body that spans a first portion of the grate aperture and leaves a second portion of the grate aperture unobstructed.

Example 39. The sink grate system of Example 38, wherein a rotational orientation of the removable drain guard determines a position of the second portion of the grate aperture.

Example 40. The sink grate system of any one of Examples 38 to 39, wherein the first portion of the grate aperture is fully obstructed by the body.

Example 41. The sink grate system of any one of Examples 38 to 39, wherein the first portion of the grate aperture is partially obstructed by the body and wherein the body comprises a second set of support members forming a second grid.

Example 42. A method of protecting a bottom surface while allowing access to a drain opening in any one of a plurality of sinks having varying sizes and varying positions of the drain opening, the method comprising: placing a primary grate comprising feet and a grate aperture in one of the plurality of sinks to determine if the primary grate has a length sufficient to substantially cover the bottom surface; connecting a first grate extension configured to be selectively positionable relative to the primary grate to extend the length of the primary grate and selecting a position of the first grate extension to achieve an extended length of the primary grate that to substantially covers the bottom surface.

Example 43. The method of Example 42 further comprising rotating the primary grate and first grate extension to align at least a portion of the grate aperture with the drain opening.

Example 44. The method of any one of Examples 42 to 43 further comprising placing a drain guard in alignment with the grate aperture, wherein the drain guard comprises a body that spans and partially obstructs a first portion of the grate aperture and leaves a second portion of the grate aperture unobstructed; and rotating the drain guard to align the second portion of the grate aperture with the drain opening.

Example 45. A method of protecting a bottom surface while allowing access to a drain opening in a sinks having a size and a position of the drain opening using the sink grate system according to any one of Examples 1 to 40, the method comprising: temporarily placing the primary grate in or over the sink to determine if the primary grate has a length sufficient to substantially cover the bottom surface; connecting the grate extension to the primary grate to selectively extend the length of the primary grate to substantially cover the bottom surface.

References to front (or forward), rear (or back), left, or right, herein generally refer to a direction of use of a sink relative to a user. As used herein, lateral generally refers to a left or right direction and longitudinal generally refers to a front or back direction, again of use of sink relative to a user. For example, when a user is standing at a sink for use of the sink, front would be a direction towards or closest to the user, rear would be a direction away or farthest from the user, right would be the user's right, and left would be the user's left. As an additional example, movement of a grate extension 104 in a lateral direction would be to the user's right or left and movement in a longitudinal direction would be toward or away from the user. As used herein, kitchenware refers to any type of implement used in a kitchen, including dishes, glassware, ovenware, utensils, pots, pans, ceramics, etc. References herein to kitchenware are exemplary only. A sink grate system according to embodiments herein may be used to support any type of item that may be placed in a sink for rinsing, cleaning, or soaking, including beakers, flasks, buckets, pets, etc. Any components or features or method steps of one embodiment or a preferred embodiment herein may be used with any other components or features or steps of other embodiments even if not specifically described with respect to that embodiment, unless such combination is explicitly excluded herein. Any component or feature or method steps described as excluded with any particular embodiment herein may similarly be excluded with any other embodiment herein even if not specifically described with such embodiment.

All numerical values for amounts, sizes, ratios, and other numeric values herein described as a range specifically include any individual value or ratio within such ranges and any and all subset combinations within ranges, including subsets that overlap from one range embodiment (such as a preferred range) to another range embodiment (such as a more preferred range) and even if the specific subset of the range is not specifically described herein. References to “about” or “around” with respect to numerical values generally mean+/−1 for values expressed as whole numbers (without a decimal, e.g., around 5 inches means 4-6 inches and around 50% means 49-51%) and +/−0.1 for values expressed with a single or more decimal place (for example, around 5.1 inches means 4.9-5.1 inches).

While various embodiments of systems and methods have been described above, it should be understood that they have been presented by way of example only, and not of limitation. Likewise, the various figures may depict an example configuration for an embodiment of a system, which is done to aid in understanding the features and functionality that can be included in systems and methods disclosed herein, but are not intended to be limiting. Although embodiments of the disclosure and certain advantages have been described in detail herein, it should be understood that various changes, substitutions, and alterations can be made herein without departing from the spirit and scope of the disclosure as defined by the appended claims. For example, embodiments are primarily described in connection with kitchen sinks; however, grate systems according to embodiments herein may also be used with other types of sinks. Moreover, the scope of the present application is not intended to be limited to the particular embodiments of systems and methods and steps described in the specification and it is intended that the scope of the invention disclosed herein be limited only by the broadest interpretation of the appended claims to which the inventor(s) is (are) legally entitled.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

Having described the various embodiments, what is claimed is as follows.

What is claimed is:

1. A sink grate system comprising:
a primary grate comprising a first outer rail, a grate aperture, and a first set of support rods; and
a grate extension comprising a second outer rail and a second set of support rods;
wherein the grate extension is configured to be selectively positionable relative to the primary grate between a first position wherein a first dimension of the sink grate system has a first value and a second position wherein the first dimension of the sink grate system has a second value; and
wherein the first value is smaller than the second value.

2. The sink grate system of claim 1 wherein the primary grate further comprises a guide channel configured to receive a portion of the second outer rail to allow the grate extension to selectively slide between the first position and the second position.

3. The sink grate system of claim 2 wherein a portion of the primary grate or a portion of the grate extension or both blocks further sliding of the grate extension relative to the primary grate when the grate extension is in the first position.

4. The sink grate system of claim 2 wherein the guide channel comprises an aperture configured to receive a fastener to hold the portion of the second outer rail in a selected position.

5. The sink grate system of claim 4 wherein the portion of the second outer rail comprises an arm and wherein a distal end of the arm is disposed to allow the fastener to contact the arm when the selected position is the first position.

6. The sink grate system of claim 2 wherein the grate aperture is not geometrically centered in the primary grate and wherein the grate aperture is configured to be alignable with a drain opening in a sink by (1) rotating the primary grate relative to the sink or (2) altering a selected position of the grate extension between the first position and the second position or (3) a combination thereof.

7. The sink grate system of claim 6 wherein a first portion of the second set of support rods obstructs a first portion of the grate aperture when the grate extension is in the first position.

8. The sink grate system of claim 7 wherein a second portion of the second set of support rods obstructs a second portion of the grate aperture when the grate extension is in the second position, and wherein the second portion of the grate aperture is smaller than the first portion of the grate aperture.

9. The sink grate system of claim 6 wherein no portion of the second set of support rods obstructs the grate aperture when the grate extension is in the second position.

10. The sink grate system of claim 6 further comprising a drain guard, wherein the drain guard comprises a third outer rail configured to engage with a portion of the primary grate, a body connected to the third outer rail; and a guard opening;
wherein the body and the guard opening are configured to align with the grate aperture;
wherein the body at least partially obstructs the grate aperture;
wherein the guard opening defines an unobstructed portion of the grate aperture; and
wherein the drain guard is selectively positionable relative to the grate aperture to align the unobstructed portion of the grate aperture with a sink drain.

11. The sink grate system of claim 10 wherein the third outer rail surrounds the body; and
wherein the guard opening is disposed outside of the third outer rail.

12. The sink grate system of claim 10 wherein the third outer rail forms a substantially L-shaped perimeter comprising a first inner leg and a second inner leg; and
wherein the guard opening is disposed between the first inner leg and the second inner leg.

13. The sink grate system of claim 10 wherein the third outer rail forms at least part of a perimeter of the guard opening.

14. The sink grate system of claim 10 wherein the third outer rail surrounds the body and the guard opening.

15. The sink grate system of claim 10 wherein the body extends down vertically from the third outer rail and comprises a third set of support rods;
wherein the first set of support rods, the second set of support rods, and the third set of support rods each define a plurality of openings that allow liquid to pass through.

16. The sink grate system of claim 10 wherein the primary grate further comprises a set of feet that elevate the first set of support rods from contact with a bottom surface of a sink.

17. The sink grate system of claim 16 wherein the grate extension is configured to be cantilevered from the primary grate.

18. The sink grate system of claim 17 wherein the grate extension is a first grate extension and wherein the sink grate system further comprises a second grate extension.

19. The sink grate system of claim 18 wherein the first grate extension is configured to be selectively positionable laterally relative to the primary grate and the first dimension is a length;
wherein the second grate extension is configured to be selectively positionable relative to the primary grate between a third position wherein a second dimension of the sink grate system has a third value and a fourth position wherein the second dimension of the sink grate system has a fourth value; and
wherein the third value is smaller than the fourth value.

20. The sink grate system of claim 19 wherein the second dimension is the length and wherein the first grate extension is configured to be selectively positionable relative to a first side of the primary grate and wherein the second grate extension is configured to be selectively positionable relative to a second side of the primary grate substantially opposite the first side.

21. The sink grate system of claim 19 wherein the second dimension is a width.

22. The sink grate system of claim 10 wherein there is only one grate extension.

23. A sink grate system comprising:
a primary grate comprising an outer rail, an inner rail defining a grate aperture, and first set of support members forming a first grid;
wherein the grate aperture is not positioned in a geometric center of the outer rail of the primary grate; and
wherein the primary grate is configured to be selectively rotatable to position the grate aperture in different locations relative to a sink drain.

24. The sink grate system of claim 23, wherein the primary grate is rectangular.

25. The sink grate system of claim 23, wherein the primary grate is circular.

26. The sink grate system of claim 23, wherein the first set of support members, the outer rail, and the inner rail are substantially coplanar.

27. The sink grate system of claim 23 further comprising a plurality of feet and wherein the sink grate system is configured so that only the plurality of feet contact a bottom of a sink in which the sink grate system is installed.

28. The sink grate system of claim 27, wherein each of the plurality of feet comprise a bent portion of one of the first set of support members.

29. The sink grate system of claim 27, wherein each of the plurality of feet further comprises an elastomeric foot cover.

30. The sink grate system of claim 23, wherein the sink grate system contains no springs or hinges.

31. The sink grate system of claim 23, further comprising:
a grate extension that is configured to laterally extend from the primary grate.

32. The sink grate system of claim 31, wherein the grate extension is configured to be selectively positionable between a fully inserted position and a fully extended position.

33. The sink grate system of claim 32 wherein the grate extension does not increase a length of the primary grate when in the fully inserted position.

34. The sink grate system of claim 32 wherein the grate extension increases a length of the primary grate by around 25 to 40% when in the fully extended position.

35. The sink grate system of claim 23, further comprising:
a removable drain guard configured to be alignable with the grate aperture.

36. The sink grate system of claim 35, wherein the removable drain guard comprises a body that spans a first portion of the grate aperture and leaves a second portion of the grate aperture unobstructed.

37. The sink grate system of claim 36, wherein a rotational orientation of the removable drain guard determines a position of the second portion of the grate aperture.

38. The sink grate system of claim 37, wherein the first portion of the grate aperture is fully obstructed by the body.

39. The sink grate system of claim 37, wherein the first portion of the grate aperture is partially obstructed by the body and wherein the body comprises a second set of support members forming a second grid.

40. A method of protecting a bottom surface while allowing access to a drain opening in any one of a plurality of sinks having varying sizes and varying positions of the drain opening, the method comprising:
placing a primary grate comprising feet and a grate aperture in one of the plurality of sinks to determine if the primary grate has a length sufficient to substantially cover the bottom surface; and
connecting a first grate extension configured to be selectively positionable relative to the primary grate to extend the length of the primary grate and selecting a position of the first grate extension to achieve an extended length of the primary grate that to substantially covers the bottom surface.

41. The method of claim 40 further comprising rotating the primary grate and first grate extension to align at least a portion of the grate aperture with the drain opening.

42. The method of claim 40 further comprising placing a drain guard in alignment with the grate aperture, wherein the drain guard comprises a body that spans and partially obstructs a first portion of the grate aperture and leaves a second portion of the grate aperture unobstructed; and
rotating the drain guard to align the second portion of the grate aperture with the drain opening.
